(19) United States
(12) Patent Application Publication
(10) Pub. No.: US 2010/0264808 A1
(43) Pub. Date: Oct. 21, 2010

(54) ELECTRON BEAM DEVICE

(75) Inventor: Kazuya Tsujino, Hiratsuka-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/722,274

(22) Filed: Mar. 11, 2010

(30) Foreign Application Priority Data
Apr. 15, 2009 (JP) 2009-098833

(51) Int. Cl. H01J 29/46

(52) U.S. Cl. 313/446

(57) ABSTRACT

In an image display apparatus having a plurality of electron emitting parts 12, in which a gate 4 and a cathode 6 are arranged in confrontation with each other, in an X-direction, electron beam control electrodes 13a and 13b are arranged, respectively on the external side of an electron emitting part 12 positioned at an end in the X-direction end portion, the electron beam control electrode 13a having the gate 4 arranged between it and the electron emitting parts 12 is connected to the cathode, and the electron beam control electrode 13b having the cathode 6 between it and the electron emitting parts 12 is connected to the gate 4, respectively.

### BACKGROUND OF THE INVENTION

1. Field of the Invention

The invention relates to an image display apparatus including an electron emitting device used for a flat panel display.

2. Description of the Related Art

Conventionally, there is known an electron emitting device in which a cathode and a gate are arranged in confrontation with each other and a confronting portion of the cathode and the gate is used as an electron emitting part. Then, an image is displayed by arranging an anode in a portion extending in an emitting direction of electrons emitted from the electron emitting device to accelerate the emitted electrons, further arranging a light emitting member behind the anode, and emitting the light emitting member by colliding electrons to the anode.

Japanese Patent Application Laid-Open No. 2001-167693 discloses an electron emitting device having a simple configuration and high electron emission efficiency and an image display apparatus including the electron emitting device. In the electron emitting device, a concave portion is formed on an insulation surface on a substrate and a cathode and a gate are formed across the concave portion so that electrons can be emitted from the cathode. To cope with recent high brightness and improved image quality required to an image display apparatus, there has been proposed to configure a display device using an electron emitting device having plural electron emitting parts in one pixel. When a device has plural electron emitting parts in one pixel, an electric field shape is made different because electrodes are differently arranged between a central portion and end portions. Accordingly, since emitted electron beams have different orbits between the central portion and the end portions, beam intensity may be made irregular in one pixel and adversely affect a displayed image.

### SUMMARY OF THE INVENTION

The present invention provides an image display apparatus excellent in display quality by making orbits of electron beams uniform in pixels in an electron emitting device having plural electron emitting parts in one pixel.

An image display apparatus according to this invention is that,

an image display apparatus comprising

a rear plate having a first substrate, a gate and a cathode arranged on the substrate and a plurality of electron emitting devices which arrange a portion where the cathode confronts with the gate as an electron emitting part, and

a face plate having a second substrate, an anode arranged in confrontation with the electron emitting device of the rear plate and accelerating electrons emitted from the electron emitting device and a light emitting member which emits light by irradiation of the electrons,

wherein the plurality of electron emitting devices have a plurality of electron emitting parts in one direction parallel to a surface of the first substrate, and the gate and the cathode are arranged together in the same arrangement direction between the electron emitting parts adjacent in the one direction; and

an electron beam control electrode is arranged on the external side of an electron emitting part positioned in at least one of the outermost portions of the respective electron emitting devices in the one direction.

In the invention, in a configuration in which plural electron emitting parts are arranged in one direction and gates and cathodes are arranged in the same direction between adjacent electron emitting parts, since an electron beam control electrode is arranged on the external side of an electron emitting part at an end, orbits of electron beams can be made uniform. Accordingly, an image display apparatus of the invention can display an excellent image having a uniform distribution of brightness.

Further features of the present invention will become apparent from the following description of exemplary embodiments with reference to the attached drawings.

### BRIEF DESCRIPTION OF THE DRAWINGS

FIG. 1A is a schematic plan view of one pixel of an image display apparatus of the invention, FIG. 1B is a schematic sectional view of the one pixel, and FIG. 1C is a schematic sectional view of one electron emitting part.

FIG. 2 is a view illustrating orbits of electron beams of the electron emitting device according to the invention.

FIG. 3 is a view schematically illustrating a configuration of the image display apparatus of the invention.

FIGS. 4A to 4I are explanatory views of operations of an electron beam control electrode according to the invention.

FIGS. 5A to 5D are views illustrating manufacturing steps of the electron emitting device in an embodiment of the invention.

### DESCRIPTION OF THE EMBODIMENTS

### First Embodiment

### (Configuration of Image Display Apparatus)

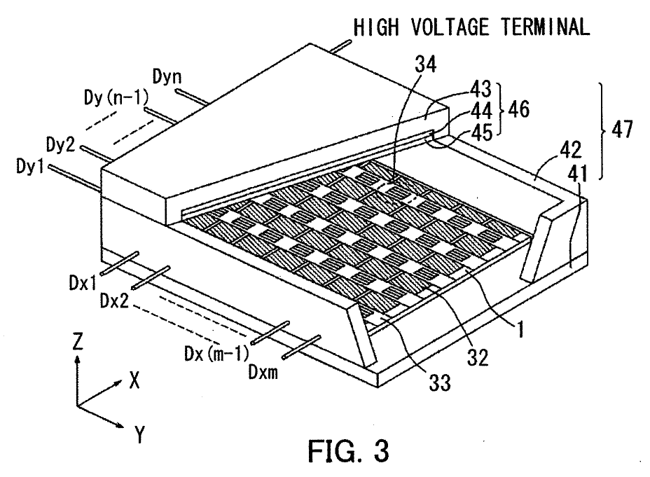

A configuration of an image display apparatus of the invention will be described using FIG. 3. FIG. 3 is a perspective view schematically illustrating a configuration example of a display panel of the image display apparatus according to the invention, wherein the perspective view is partially cut out to show an internal structure of the display panel. In the view, reference numeral 1 denotes a substrate, 32 denotes a scan wiring, 33 denotes a modulation wiring, and 34 denotes an electron emitting device. Reference numeral 41 denotes a rear plate on which the substrate (first substrate) 1 is fixed, 46 denotes a face plate in which a phosphor 44 as a light emitting member, a metal back 45 as an anode, and the like are formed on an inner surface of a glass substrate (second substrate) 43. Reference numeral 42 denotes a support frame, and an external enclosure 47 is configured by attaching the rear plate 41 and the face plate 46 to the support frame 42 through a flit glass and the like. Since the rear plate 41 is arranged for purposes of mainly reinforcing the strength of the substrate 1, when the substrate 1 has a sufficient strength by itself, the rear plate 41 as a separate member is not necessary. Further, a configuration having a sufficient strength to atmospheric pressure can be also provided by interposing a not illustrated support member called a spacer between the face plate 46 and the rear plate 41.

M pieces of scan wirings 32 are connected to terminals Dx1, Dx2, . . . , Dxm. N pieces of modulation wirings 33 are connected to terminals Dy1, Dy2, . . . , Dyn (m and n are positive integers). Not illustrated interlayer insulating layers are arranged between the m pieces of the scan wirings 32 and the n pieces of the modulation wirings 33 to electrically separate them from one another. A high voltage terminal is connected to a metal back 45, and a direct current voltage of 10 [kV], for example, is supplied to the metal back 45. The voltage is an acceleration voltage for applying a sufficient energy for exciting a phosphor to electrons emitted from the electron emitting device.

The rear plate according to the invention has the plural electron emitting devices 34 connected in a matrix state by the scan wirings 32 and the modulation wirings 33. A scan circuit (not illustrated) is connected to the scan wirings 32 to apply a scan signal for selecting a row of the electron emitting devices arranged in an X-direction. In contrast, a modulation circuit (not illustrated) is connected to the modulation wirings 33 to modulate respective columns of the electron emitting device 34 arranged in a Y-direction in response to an input signal. A drive voltage applied to the respective electron emitting devices is supplied as a difference voltage between a scan signal and a modulation signal applied to the electron emitting devices. The drive voltage is preferably in a range of 10 V to 100 V and more preferable in a range of 10 V to 30 V.

### (Configuration of Electron Emitting Device)

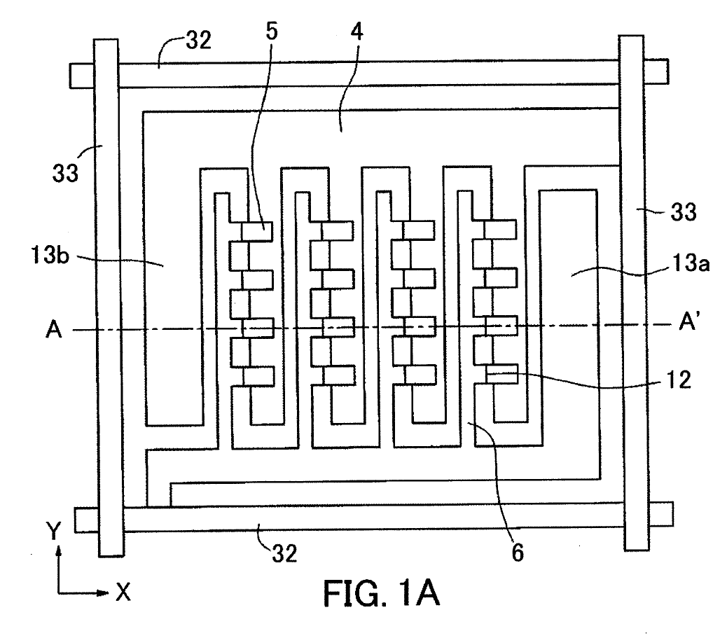

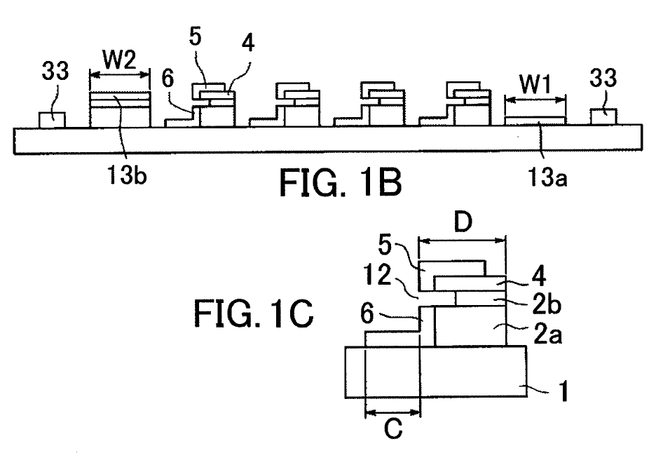

FIGS. 1A to 1C are views schematically illustrating a configuration of the electron emitting device of one pixel arranged on the rear plate of the image display apparatus according to the invention. FIG. 1A is a schematic plane view of the electron emitting device, FIG. 1B is a schematic sectional view of an A-A′ section of FIG. 1A, and FIG. 1C is a schematic sectional view illustrating a combination structure of a cathode and a gate constituting one electron emitting part of FIG. 1B. In the figures, reference numerals 2a and 2b denote insulating layers, 4 denotes a gate, 5 denotes a gate projecting portion, 6 denotes a cathode, 12 denotes an electron emitting part, 13a and 13b denote electron beam control electrodes, and the same components as those of FIG. 3 are denoted by the same reference numerals.

The electron emitting device according to the invention includes the gate 4 and the cathode 6 arranged on a substrate. In the example, the cathode 6 is connected to a scan wiring 32, and a cathode potential is applied to the cathode 6. Further, the gate 4 is connected to a modulation wiring 33, and a gate potential is applied the gate 4. In the example, any of the cathode 6 and the gate 4 is formed in a comb-teeth shape, and the cathode 6 and the gate 4 are arranged so that the comb-teeth are located alternately in the X-direction. Further, each of the comb-shaped teeth of the cathode 6 is formed to have a portion projecting in confrontation with the gate 4. Although the example has the projecting portions located at four positions, the number of the portions is not limited thereto. Further, the gate 4 has a projecting portion 5 to correspond to the projecting portion of the cathode 6 so that it confronts the gate 4. Note that the projecting portion 5 is substantially a part of the gate 4. In the invention, the projecting portion 5 of the gate 4 and the projecting portions of the cathode 6 constitute the electron emitting part 12 by confronting one another.

As illustrated in FIG. 1, in the invention, plural electron emitting parts 12 each including the gate 4 and the cathode 6 confronting each other in one pixel are arranged together in one direction (in the X-direction in the example) parallel to a surface of the substrate. In the parallel configuration, as illustrated in FIG. 1, all the arrangement directions of the gates 4 and the cathodes 6 positioned between adjacent electron emitting parts are the same in the X-direction.

In the above configuration of the invention, electron beam control electrodes are arranged on the external side of an electron emitting part 12 positioned to at least one of outermost portions in the X-direction. In the example, an electron beam control electrode 13a is arranged on the external side of an electron emitting part 12 at a right end, and an electron beam control electrode 13b is arranged on the external side of an electron emitting part 12 at a left end, respectively.

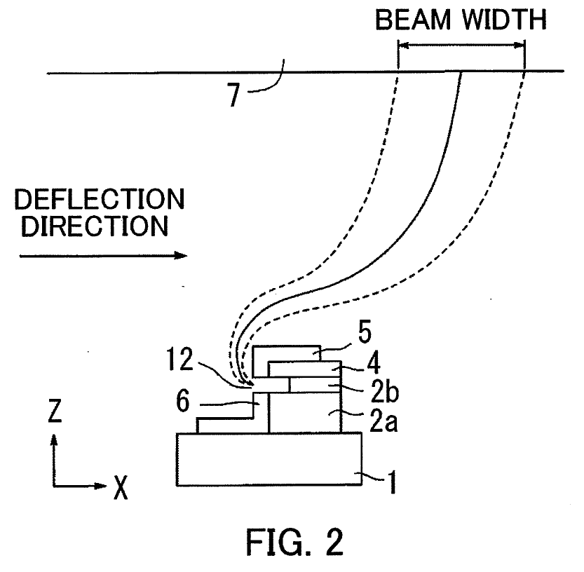

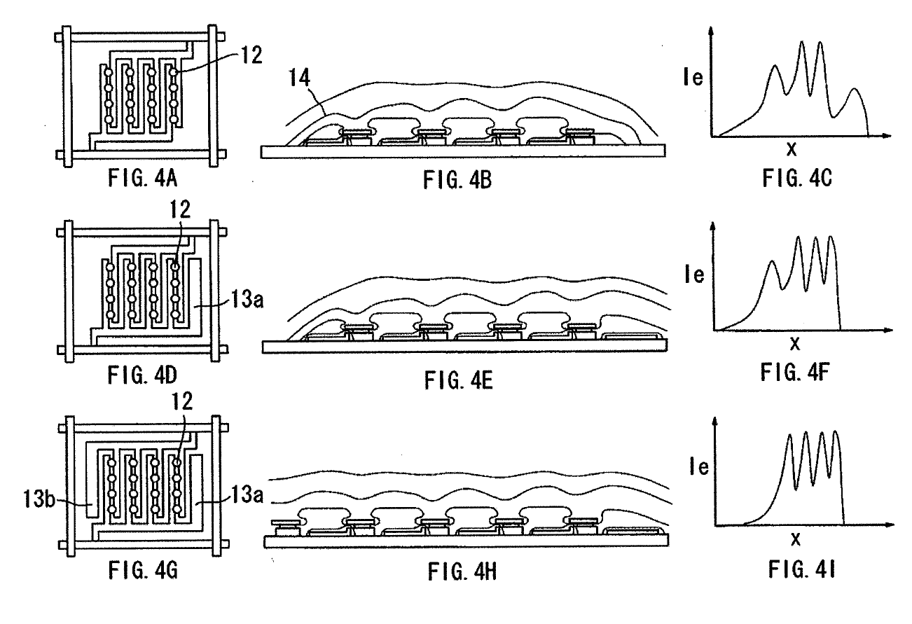

An operation of the electron beam control electrodes 13a and 13b will be described using FIGS. 2 and 4.

FIG. 2 is a view illustrating orbits until electrons emitted from the electron emitting part 12 illustrated in FIG. 1 reach an anode 7. The electrons emitted from the electron emitting part 12 are deflected by the gate 4 in the X-direction (corresponding to “deflection direction” of the example). Further, the electrons emitted from the electron emitting part 12 are affected by a peripheral electric field and reach the anode 7 while being diffused.

FIG. 4A is schematic plan view illustrating the same pixel configuration as that of FIG. 1 except that the electron beam control electrodes 13a and 13b do not exist. In this case, in electron emitting parts 12 positioned on an outermost side, adjacent electron emitting parts 12 exist only on one side in the X-direction. Thus, a disposition of peripheral electrodes is different from that of a central portion, and a periodic property of a peripheral electric field is collapsed as illustrated in FIG. 4B. Incidentally, reference numeral 14 in the figure denotes an equipotential line. Accordingly, a beam profile (an emission current distribution in the X-direction) to a deflection direction of electrons emitted from the electron emitting parts is as illustrated in FIG. 4C. Thus, in this case, a diffusion of the electrons emitted from an electron emitting device cannot be suppressed.

FIG. 4D is a schematic plan view illustrating a pixel configuration in which the electron beam control electrode 13a is arranged on only the external side of the electron emitting parts 12 at a right end. In this case, a periodic property of a peripheral electric field of the electron emitting parts 12 is collapsed only on the side (left side) where the control electrode 13a is not arranged as illustrated in FIG. 4E and thus a beam profile to a deflection direction of the electrons emitted from the electron emitting parts 12 is as illustrated in FIG. 4F. Accordingly, a configuration is improved as compared with that of FIG. 4A.

FIG. 4G is a schematic plan view illustrating a configuration in which the electron beam control electrodes 13a and 13b are arranged at both the ends of the X-direction, and the configuration corresponds to the configuration of FIG. 1A. In the configuration, a periodic property of an electric field in a central portion in the X-direction is kept up to the electron emitting parts 12 of both the ends as illustrated in FIG. 4H, and orbits of the electrons emitted from respective electron emitting parts 12 are made uniform. Thus, a beam profile to a deflection direction is as illustrated in FIG. 4I, and a diffusion of the electrons emitted from the electron emitting parts 12 can be sufficiently suppressed.

In the invention, to sufficiently exhibit an effect obtained from a width W1 of the electron beam control electrode 13a and from a width W2 of the electron beam control electrode 13b in the X-direction, it is preferable to satisfy a relation of W1≧C, W2≧D between a width C of the cathode 6 and a width D of the gate 4.

Incidentally, in the example, the electron beam control electrode 13a, which is arranged on the external side of the gate 4, is connected to the cathode 6 and set to a cathode potential, and the electron beam control electrode 13b, which is arranged on the external side of the cathode 6, is connected the gate and set to a gate potential. Although the configuration is a preferable configuration to control potentials of the electron beam control electrodes 13a and 13b, the invention is not limited thereto. In the invention, it is sufficient that the periodic property of the electric field of the central portion is kept up to a periphery of the electron emitting part 12 on the outermost side and that orbits of electrons are made uniform, and potentials of the control electrodes 13a and 13b may be separately controlled in a range in which the effect can be obtained.

### (Method of Manufacturing an Electron Emitting Device)

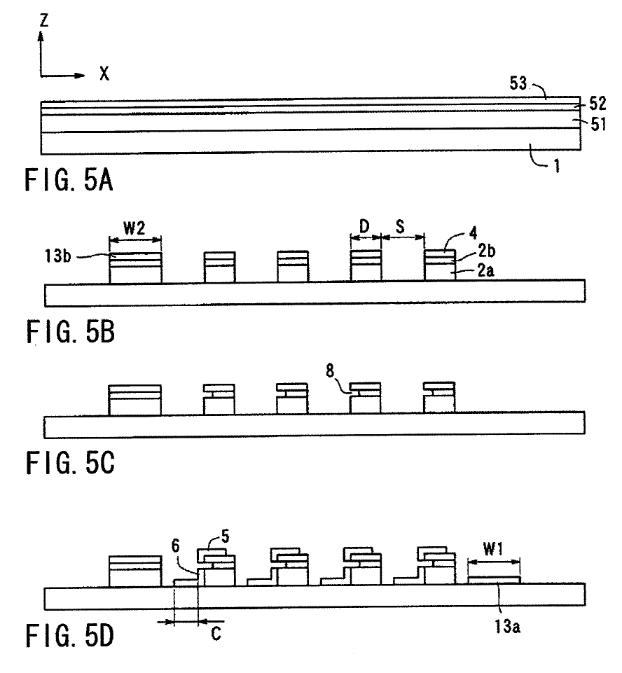

Next, a method of manufacturing the electron emitting device of the invention will be described by exemplifying a configuration example of FIG. 1 using FIG. 5.

The substrate 1 is an insulating substrate for mechanically support a device. For example, a quartz glass, a glass in which a content of impurities such as Na is reduced, a blue sheet glass, and a silicon substrate may be used as the substrate 1. A function necessary for the substrate 1 is a resistance property to dry etching, wet etching, and alkaline and acid of a developer and the like and in addition to that it has a high mechanical strength. Further, when the substrate 1 is used as an integrated member such as a display panel, it is preferable that the substrate 1 has a small thermal expansion difference between it and a film forming material and other laminating material. Further, the substrate is desirably a material in which an alkaline element and the like are unlike to be diffused from the inside of a glass in a heat treatment.

As illustrated in FIG. 5, insulating layers 51, 52 and a conductive layer 53 are sequentially laminated on the substrate 1. The insulating layer 51 is an insulating film including a material excellent in a processing property and, for example, SiN (SiₓN_{y}) and SiO₂ and formed by an ordinary vacuum film forming method such as sputtering and the like, a CVD method, and a vacuum vapor deposition method. Next, the insulating layer 52 is formed on the insulating layer 51 by the CVD, the vacuum vapor deposition method, and the ordinary vacuum film forming method such as the sputtering and the like. A thickness of the insulating layers 51 and 52 is set in a range of 5 nm to 50 μm and is preferably selected in a range of 50 nm to 500 nm. A material having a different etching speed in etching is preferably selected as the insulating layers 51 and 52. The insulating layers 51 and 52 preferably have a selection ratio of 10 or more and more preferably have a selection ratio of 50 or more therebetween. Specifically, for example, SiₓN_{y} may be used for the insulating layer 51 and an insulating material such as SiO₂ may be used for the insulating layer 52 or a PSG film having a high phosphorus concentration, a BSG film having a high boron concentration, and the like may be used for the insulating layer 52.

Further, the conductive layer 53 acts as the gate 4 of FIG. 1 and is formed by the ordinary vacuum film forming technique such as the vapor deposition method, the sputtering. A material having a high thermal conductivity and a high melting point in addition to a conductive property is preferable as the conductive layer 53. For example, metals or alloy materials such as Be, Mg, Ti, Zr, Hf, V, Nb, Ta, Mo, W, Al, Cu, Ni, Cr, Au, Pt, Pd, and the like and carbides such as TiC, ZrC, HfC, TaC, SiC, WC, and the like are exemplified. Further, borides of HfB₂, ZrB₂, CeB₆, YB₄, GdB₄, and the like, nitrides of TiN, ZrN, HfN, TaN, and the like, semiconductors of Si, Ge, and the like, and organic polymer materials are also exemplified. Further, amorphous carbons, graphites, diamond-like carbons, and carbons, carbon compounds, and the like to which diamonds are dispersed are also exemplified, and the material of the conductive layer 53 is appropriately selected therefrom. A thickness of the conductive layer 53 is set to a range of 5 nm to 500 nm and is preferably selected in a range of 20 nm to 500 nm.

Next, as illustrated in FIG. 5B, after a resist pattern is formed on the conductive layer 53 by a photolithographic technique, the conductive layer 53, the insulating layer 52, and the insulating layer 51 are sequentially processed using an etching method. With this configuration, the gate 4, the insulating layer 2b, the insulating layer 2a, and the electron beam control electrode 13b can be obtained. In the etching process, Reactive Ion Etching (RIE), which can etch a material precisely by ordinarily making an etching gas to plasma and radiating it to the material. When a target member to be processed creates fluorides, a fluorine gas such as CF₄, CHF₃, and SF₆ may be selected as a processing gas at the time. Further, when chlorides are formed as in Si and Al, a chloride gas such as Cl₂, BCl₃ is selected. Further, to obtain a selection ratio to a resist, hydrogen, oxygen, an argon gas, and the like are added when it is necessary to secure flatness of an etched surface or to increase an etching speed. The etching process may be stopped on an upper surface of the substrate 1, or a part of the substrate 1 may be etched.

Incidentally, the number n of the gates 4 arranged in the X-direction and a length D of each gate 4 in the X-direction, and an interval S between each gate 4 and an adjacent device may be appropriately changed. D is preferably in a range from 5 μm to 50 μm. Further, as described above, it is preferable to set W2≧D.

Next, as illustrated in FIG. 5C, only a side surface of the insulating layer 2 a is partially removed on one side surface of a laminated body including the insulating layers 2a and 2b and the gates 4 using the etching method, and a concave portion 8 is formed. In the etching method, when, for example, the insulating layer 2b is a material including SiO₂, a mixed solution of ammonium fluoride ordinarily called buffer fluoride acid (BHF) and hydrofluoric acid may be used. Further, when the insulating layer 2b is a material including SiₓN_{y}, the etching can be performed by a thermal phosphorus acid etching solution. A depth of the concave portion 8, that is, a distance between a side surface of the insulating layer 2b and a side surface of the insulating layer 2a in the concave portion 8 is preferably formed in about 10 nm to 200 nm.

In the example, although a mode in which the insulating layers 2a and 2b are laminated, the invention is by no means limited thereto, and the concave portion 8 may be formed by removing a part of one insulating layer.

Next, as illustrated in FIG. 5D, a conductive material is deposited on the substrate 1 and on a side surface of the insulating material 2a. At the time, the conductive material is deposited also on the gate 4. Further, with this configuration, the projecting portion 5, the cathode 6, and the electron beam control electrode 13a can be obtained. As the conductive material, any material may be used as long as it has conductivity and emits electrons to an electric field. The conductive material is preferably a material which has a high melting point of 2000° C. or higher and a job function of 5 eV or lower and is unlike to form a chemical reaction layer such as oxides or can simply remove a reaction layer. Exemplified as the material are for example, metals or alloys such as Hf, V, Nb, Ta, Mo, W, Au, Pt, Pd, carbides such as TiC, ZrC, HfC, TaC, SiC, WC, and borides such as HfB₂, ZrB₂, CeB₆, YB₄, GdB₄. Further, exemplified as the material are nitrides such as TiN, ZrN, HfN, TaN and carbons and carbon compounds in which amorphous carbon, graphite, diamond-like carbon and diamonds are dispersed. As a deposition method of the conductive material, the ordinary vacuum film forming technique such as the vapor deposition method and the sputtering method are used, and an EB vapor deposition method is preferably used.

A length C of the cathode 6 in the X-direction may be appropriately changed. A length D is preferably in a range from 5 μm to 50 μm. Further, the length D is preferably set to W1≧C as described above.

A structure of the electron emitting device, which can be applied to the invention, is not limited to the mode described here. Any electron emitting device, which has plural gates for deflecting electrons emitted from plural electron emitting parts in the same direction asymmetrically, can be applied to the invention. As a configuration of the electron emitting part, any arbitrary configuration of a lateral electric field emission device of Spindt-type, a Metal-Insulator-Metal emitting device (MIM-type device), a surface conductive device (surface conductive emitting device), and the like may be employed.

### Example 1

An electron emitting device having the configuration illustrated in FIG. 1 was made according to steps of FIG. 5. The respective steps will be described below.

### <Step 1>

A blue sheet glass was used as a substrate 1, and after the substrate 1 was sufficiently rinsed, a Si₃N₄ film having a thickness of 300 nm was deposited as an insulating layer 51 by sputtering, and next, a SiO₂ film having a thickness of 20 nm was deposited as an insulating layer 52 by sputtering. Thereafter, TaN of 30 nm was deposited as a conductive layer 53 [FIG. 5A].

### <Step 2>

Next, a positive photoresist was spin-coated, a photo mask pattern was exposed and developed, and a resist pattern was formed. At the time, the resist pattern was formed so that it was set to D=10 μm, S=12 μm, and W2=20 μm. Thereafter, the conductive layer 53, the insulating layer 52, and the insulating layer 51 were dry-etched using CF₄ gas and the patterned photoresist as a mask. The dry etching was stopped on the substrate 1, and a laminated body including insulating layers 2a and 2b, and a gate 4 or an electron beam control electrode 13b was formed [FIG. 5B].

### <Step 3>

Next, the thus formed laminated body was etched for 11 minutes using buffer-fluorinated (BHF) acid (LAL100 made by Stera Chemifa Corporation) as an etching solution, and the insulating layer 2b was selectively etched. A concave portion 8 was formed by etching the insulating layer 2b about 60 nm from a side surface of the laminated body [FIG. 5C].

### <Step 4>

Next, Mo having a thickness of 30 nm was selectively deposited as a projecting portion 5, a cathode 6, and an electron beam control electrode 13a by oblique deposition from an oblique direction of 45°. At the time, a resist pattern was formed so that it was set to C=10 μm, W1=20 μm [FIG. 5D].

### Example 2

An electron emitting device was made similarly to the example 1 except that the electron beam control electrode 13b was not formed at step 2.

### Comparative Example 1

An electron emitting device was made similarly to the example 1 except that the electron beam control electrode 13b was not formed at step 2 and further even the electron beam control electrode 13a was not formed at step 4.

An image display apparatus was made using each of the substrates to which the respective electron emitting devices of the examples 1, 2 and the comparative example 1 were formed as a rear plate and disposing the face plate illustrated in FIG. 3 at a position which is away from the rear plate by 1.6 mm, and the image display apparatus was driven by setting an anode voltage to 12 kV. As a result, a beam width in the example 1 was 116 μm, abeam width in the example 2 was 130 μm, and a beam width in the comparative example 1 was 180 μm in a deflection direction (the X-direction) on the face plate, respectively. Accordingly, it has been found that diffusion of electrons can be suppressed by arranging the electron beam control electrode on at least one side or preferably on both the sides.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-098833, filed on Apr. 15, 2009, which is hereby incorporated by reference herein its entirety.

What is claimed is:

1. An image display apparatus comprising
a rear plate having a first substrate, a gate and a cathode arranged on the substrate and a plurality of electron emitting devices which arrange a portion where the cathode confronts with the gate as an electron emitting part, and
a face plate having a second substrate, an anode arranged in confrontation with the electron emitting device of the rear plate and accelerating electrons emitted from the electron emitting device and a light emitting member which emits light by irradiation of the electrons,
wherein the plurality of electron emitting devices have a plurality of electron emitting parts in one direction parallel to a surface of the first substrate, and the gate and the cathode are arranged together in the same arrangement direction between the electron emitting parts adjacent in the one direction; and
an electron beam control electrode is arranged on the external side of an electron emitting part positioned in at least one of the outermost portions of the respective electron emitting devices in the one direction.

2. An image display apparatus according to claim 1, wherein
the electron beam control electrode is connected to the cathode, and
the gate is positioned between the electron emitting parts positioned in the outermost portion and the electron beam control electrode.

3. An image display apparatus according to claim 2, wherein
a width C of a cathode in the one direction and a width W1 of the electron beam control electrode satisfy a relation of W1≧C.

4. An image display apparatus according to claim 1, wherein
the electron beam control electrode is connected to a gate,
a cathode is positioned between the electron emitting parts positioned in the outermost portions and the electron beam control electrode.

5. An image display apparatus according to claim 4, wherein
a width D of a gate in the one direction and a width W2 of the electron beam control electrode satisfy a relation of W2≧D.
